(19) United States
(12) Patent Application Publication
(10) Pub. No.: US 2010/0213687 A1
(43) Pub. Date: Aug. 26, 2010

(54) TRAILER HITCH ASSEMBLY

(76) Inventors: PATRICK KERMIT MCDANIEL, Kennewick, WA (US); Earl Lloyd Penor, JR., Benton City, WA (US)

Correspondence Address: FLOYD E. IVEY;IVEY Law Offices, P.S. Corp., 7233 W. Deschutes Ave., Suite C, BOX #3, KENNEWICK, WA, 99336, US

(21) Appl. No.: 12/392,027

(22) Filed: Feb. 24, 2009

(51) Int. Cl. B60D 1/155

(52) U.S. Cl. 280/491.2

(57) ABSTRACT

A Telescoping and Articulated Trailer Hitch Assembly has a telescope extension tube (18) which slidably receives a trailer hitch extension (10). The trailer hitch extension (10) is rotatably affixed to a trailer hitch ball assembly (12) by a pivot pin (14). The pivot pin (14) has a diameter and is pivotally received by at least one outwardly extending upper pivot pin receiver having a pivot pin aperture (60) and by at least one outwardly extending lower counterbore receiver having a counterbore (64). The at least one upper pivot pin aperture (60) and the at least one lower counterbore (64) have an inside diameter greater than the pivot pin (14). The at least one lower counterbore (64) is penetrated, at the bottom, by an access aperture (66) which allows upward force to be applied to the pivot pin (14) for ease of removal and replacement of the trailer hitch ball assembly (12) with a different hitch style. The trailer hitch ball assembly (12) has at least one outwardly extending hitch pivot pin aperture (62) which has a diameter greater than the pivot pin (14) diameter. The alignment of the pivot pin aperture (60), the hitch pivot pin aperture (62) and the lower counterbore (64) allows the insertion of the pivot pin (14). The trailer hitch extension (10) is extended by a drive interconnection with a Gearhead and Motor Drive Subassembly (22), which drives an Acme Screw (20), via an actuated Acme Screw Drive (21), to extend or retract the trailer hitch extension (10). When the Acme Screw Drive Assembly 22 is driven in one direction, the trailer hitch extension (10) is telescoped outwardly allowing a Ball Mount (12) to swing to either the left or right via the Pivot Pin (14) thus allowing a generous amount of misalignment between a Tow Vehicle and a Trailer.

### FIELD OF THE INVENTION

This invention relates to a trailer hitch assembly.

### BACKGROUND OF THE INVENTION

This Trailer Hitch is used to couple and decouple a Trailer without the need of additional assistance.

### SUMMARY OF THE INVENTION

To hitch the Vehicles together, one simply operates a switch attached to the Hitch on the Tow Vehicle that controls the lateral motion of the Linear Actuator in the out-motion. When the Drawbar is telescoped outwardly to its full extension, the last portion of the Drawbar is pivotal. The Operator now can back the Tow Vehicle to the Trailer Coupler without concern of being directly under the Coupler. Once backed to the Trailer Coupler, the Operator can either pivot and or telescope the Drawbar Assembly, with the Hitch Ball attached to its' pivotal end, so that it is directly under the Trailer Coupler.

Next, the Operator lowers the Trailer Coupler onto the Hitch Ball via the Trailer Tongue Jack and secures the Latch. Once this is accomplished, the Operator operates the Linear Actuator Switch to retract the Drawbar Assembly inwardly into the Standard Trailer Hitch Receiver. When the pivotal portion of the Drawbar reaches the leading edge of the Hitch Receiver, it will be forced into alignment by the retracting force of the Linear Actuator. Then the Operator inserts a Safety Locking Pin to prevent the Assembly from inadvertently telescoping back out.

The Hitch has a self-contained Cowling containing the Linear Actuator Control Switch as well as the Trailer Wiring Harness Connection Receptacle. This Cowling also provides a convenient Step to make it easier to access the Tow Vehicle Rear Compartment.

The patents referred to herein are provided herewith in an Information Disclosure Statement in accordance with 37 CFR 1.97.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

The Trailer Hitch is illustrated in the drawings within: FIG. 1 is a perspective top view of the Trailer Hitch showing the Ball Mount and Stinger (common name), extended out and rotated to one side.

FIG. 2 is an exploded view of the Trailer Hitch with the same components as in FIG. 1.

FIG. 3 is a partial view of the Ball Mount and Stinger shown sectioned to reveal the internal passage holes required for component operations.

FIG. 4 is a partial view of the Receiver Tube, Stinger and Ball Mount. This view is partially sectioned to show details of the fully extended locking device.

FIG. 5 is a partial view looking upward to reveal how the “quick change” pin is removed from the unit to allow different Ball Mounts to be easily and quickly changed.

FIG. 6 is a view looking upward to show the Components of an alternate method to extend and retract the Ball Mount manually rather than the Electronic Actuator.

FIG. 7 is a view looking upward to show the Components of another alternate method to extend and retract the Ball Mount using a permanently mounted “Bottle Jack”.

FIG. 8 is a view looking upward to show the Components of another alternate method to extend and retract the Ball Mount using a Hydraulic Cylinder and Pump.

FIG. 9 is a view showing a “Drop Stinger” (common name), that can be substituted for the Ball Mount if a lower distance is needed to connect to the Trailer Coupler.

FIG. 10 is an Equalizing Stinger (common name), that can be used if Trailer Equalizing Mechanisms are to be used in the Towing Operation.

FIG. 11 is a view looking upward to show the Components that are required to suspend the Hitch below the Spare Tire under the Pickup Bed.

FIG. 12 illustrates an Industry Standard Pintle Hook adapted for use with the Preferred Embodiments in all the other Figures. Common uses are Farm and Heavy Equipment Machinery.

FIG. 13 is an exploded View illustrating a Pintle Hook Style Hitch commonly used by the Military for Heavy Equipment, such as the Howitzer Cannon. The Pintle must rotate 360 degrees about the center Axis because of the rough terrains often encountered. The Drive Mechanism used in this illustration is a double acting Hydraulic Cylinder Pump driven, but could easily be driven by any of the other Drive Alternatives in the other Specifications.

### DESCRIPTION OF PREFERRED EMBODIMENTS

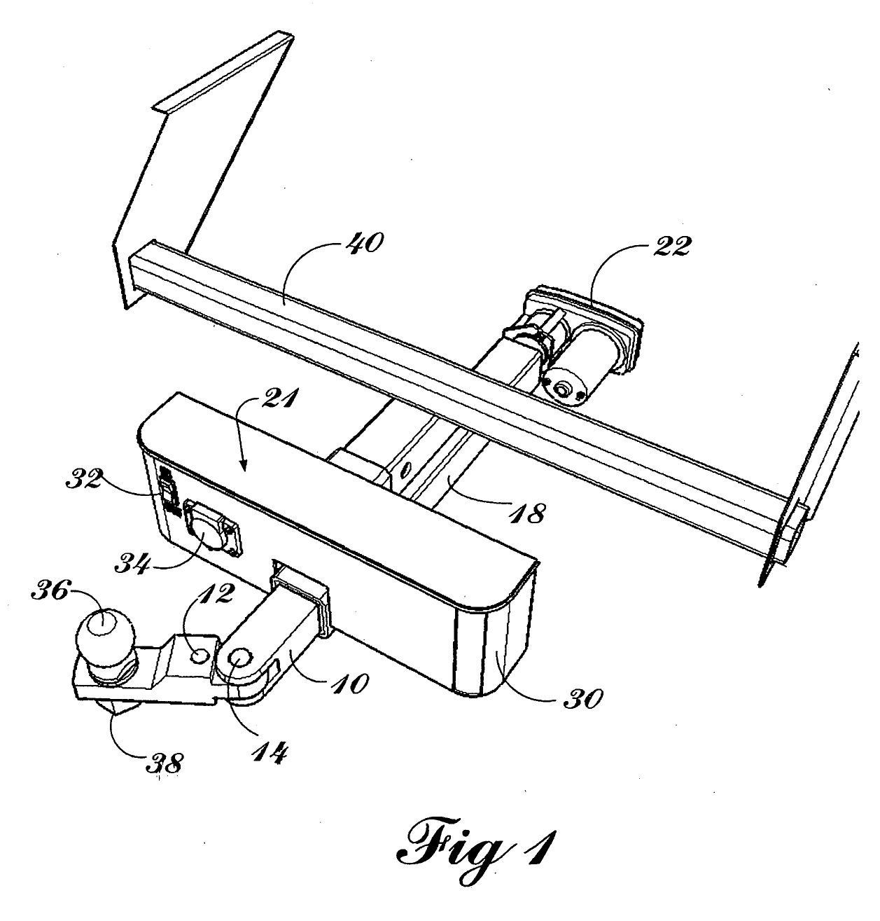

Preferred embodiments of the Trailer Hitch are illustrated in FIGS. 1 through 10 in the drawings. FIGS. 1, 2 & 5 illustrate most of the major Components of the Electronic version of the Hitch. Major Components 10 & 12 are made up of commonly called “Stinger Hitch Stock”, but could also be fabricated from other Structural Members. These two Components, 10 & 12 are joined together by Pivot Pin 14 that passes through Holes 60, 62 & 64, but does not pass through Hole 66 described later. Item 12 has a Hole 68 for insertion of a Standard Hitch Ball 36 and secured with Standard Hitch Ball Nut 38. Pivot Pin 14 allows items 10 & 12 to articulate. This articulation will allow for a generous amount of misalignment of the Tow Vehicle and the Towed Vehicle during Trailer coupling operations.

Items 10, 12 & 14 comprise a Subassembly 11 that includes a Nut 16 at its' end opposite the Pivot Pin 14. Nut 16 contains an Acme Screw Thread 46. This Subassembly telescopes in and out of Item 18 which is an Industry Standard Tubing 18, referred to as a Hitch Receiver. Forward of Nut 16 is a Cylindrical Cavity 42. Gearhead and Motor Drive Subassembly 22, drives an Acme Screw 20 that threads through Acme Nut 16. This Drive Subassembly 21 is affixed to the rearward end of Tube 18 by any suitable means. When the Acme Screw Drive Assembly 21 is driven in one direction, the Subassembly 11 is telescoped outwardly allowing the Ball Mount 12 to swing to either the left or right via the Pivot Pin 14. This will allow a generous amount of misalignment between the Tow Vehicle and the Trailer. When the Acme Screw Drive 21 is driven in the opposite direction, the telescoping Assembly 11 is retracted inwardly through Tube 18. When Ball Mount 12 Strikes the outer Surfaces of Tube 18, it is forced to straighten itself via Pivot Pin 14 allowing it to retract fully inside the Tube 18. When Pivot Pin 14 is fully retracted to within the Tube 18, it can no longer allow the Pivot Action of Ball Mount 12. This will be its towing position.

Subassembly 25 consists of items 24 and 26 which are square “Hitch Stinger Stock” welded together and in turn welded at the forward end of Receiver Tube 18. The rearwardly end of Subassembly 25 is inserted into the forward end of the Standard Hitch Receiver 40 of the Tow Vehicle. Pin 27 is inserted through Holes 29 and 31 to secure the entire Hitch Assembly for Towing.

Structural Member 28 is welded to the top of Hitch Subassembly 25 to receive Cowling Cover 30 which also provides a Step for better access to the rear Bed of a Pickup Truck Tow Vehicle. Control Switch 32 is inserted into mount Hole 33. The Control Switch 32 is 3 then hard wired to the Motor on the Drive Subassembly 21. Trailer wiring receptacle 34 is inserted into Hole 35. A short section of Wiring Harness 43 is provided with a Male Connector 45 that will be inserted into the Standard Hitch Wiring Receptacle 41 on the Tow Vehicle. A hot lead 47 will be taken from this Harness 43 to route to the Motor on Drive Assembly 21 through the Control Switch 32. This wiring scenario will prevent the user from requiring the need to provide separate wiring from the Tow Vehicle to operate the Hitch Assembly.

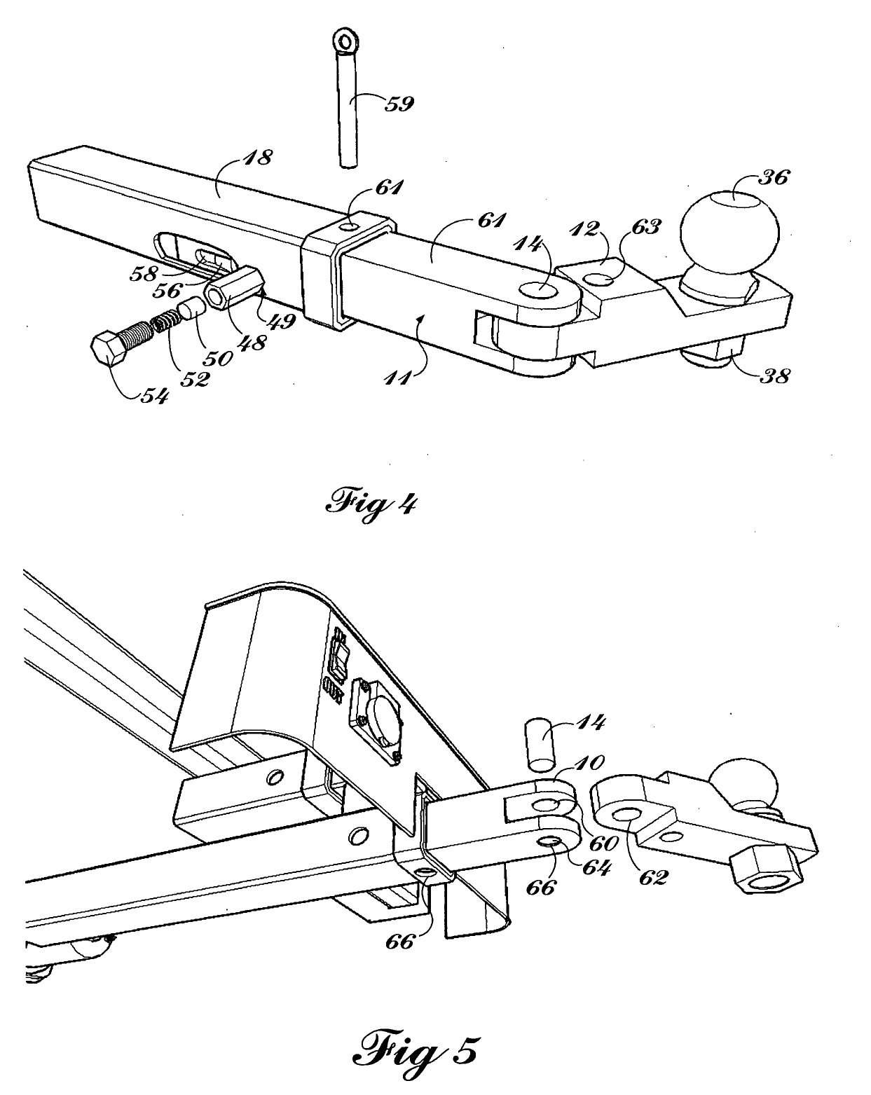

In FIG. 4, Coupling Nut 48 is welded to the side of Hitch Tube 18 over a Hole 49. A short Pin 50 is inserted into this Nut. Spring 52 is then inserted and Bolt 54 is screwed into the Coupling Nut 48 to secure the Components together. A notch 58 with Ramp 56 is provided in the Face of Telescoping Stinger 10. When telescoping Stinger Assembly 11 is extended outwardly to Hitch the Trailer, the pin 50 will slide down the Ramp 56, due to the force of the Spring 52, and stop at Notch 58, preventing the Telescoping Stinger Assembly 11 from screwing itself out of Acme Nut 16.

Also in FIG. 4, Pit Pin 59 is inserted through Holes 61 at top of Stinger Tube 18 through Hole 63 in Ball Mount 12 and passing through the Hole in the bottom of Stinger Tube 18 FIG. 5. This Pit Pin 59 secures the Telescoping Stinger and Ball Mount Assembly 11 remains in place during the Towing operation. This Pit Pin 59 also unloads the extreme forces exerted on the weaker Components of all the Hitch Assembly during the Towing operation.

### Description of Alternate Drive Method #1

FIG. 6 illustrates a mechanical Screw Drive method of Telescoping the Hitch Assembly 11 in and out. Acme Screw Bearing 72 is affixed to the end of telescoping Stinger 10. Acme Nut 68 is affixed to the Stinger Receiver Tube 18. Acme Screw 70 is fixed to the Acme Bearing 72 and passes through the Acme Nut 68 and then through a Hole in Cowling Step Assembly 24. The protruding end of the Acme Screw 70 has a Hexagonal form so it can be operated by any Tool such as a Ratchet or Power Drill with a Socket Attachment.

### Description of Alternate Drive Method #2

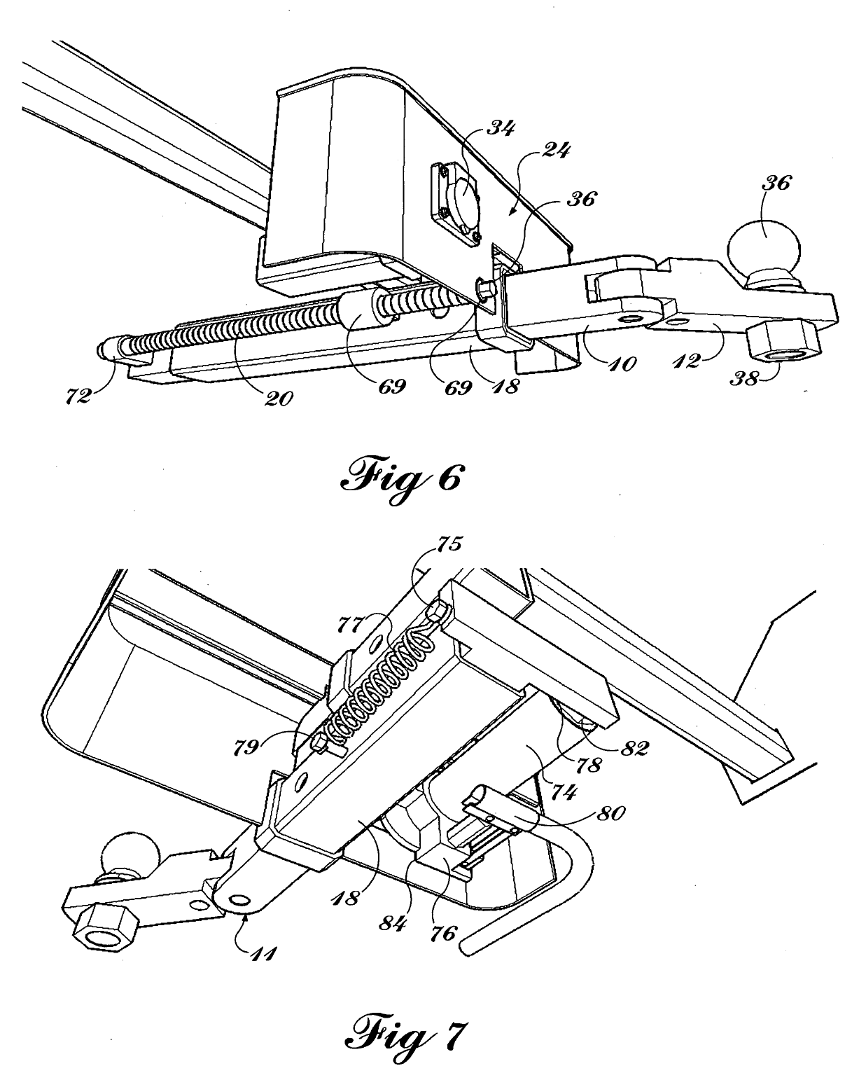

FIG. 7 illustrates an Industry Standard Hydraulic Bottle Jack 74 used to retract the Hitch Telescoping Stinger Assembly 11. Bottle Jack Base 84 of Bottle Jack 74 is affixed to Surface 76, by any suitable means. Bottle Jack Ram 82 pushes against Surface 78 of Stinger 10 at its' rearwardly portion to retract the Telescoping Stinger Assembly 11. When the pressure is relieved on Bottle Jack 74, the Telescoping Stinger Assembly 11 is allowed to extend outwardly due the tensional forces of Spring 77. One end of Spring 77 is attached to the Telescoping Stinger Assembly with a Bolt 75 (or any suitable means,) and the other end is attached to the Tube Assembly 18 by another Bolt 79 (or any suitable means.)

### Description of Alternate Drive Method #3

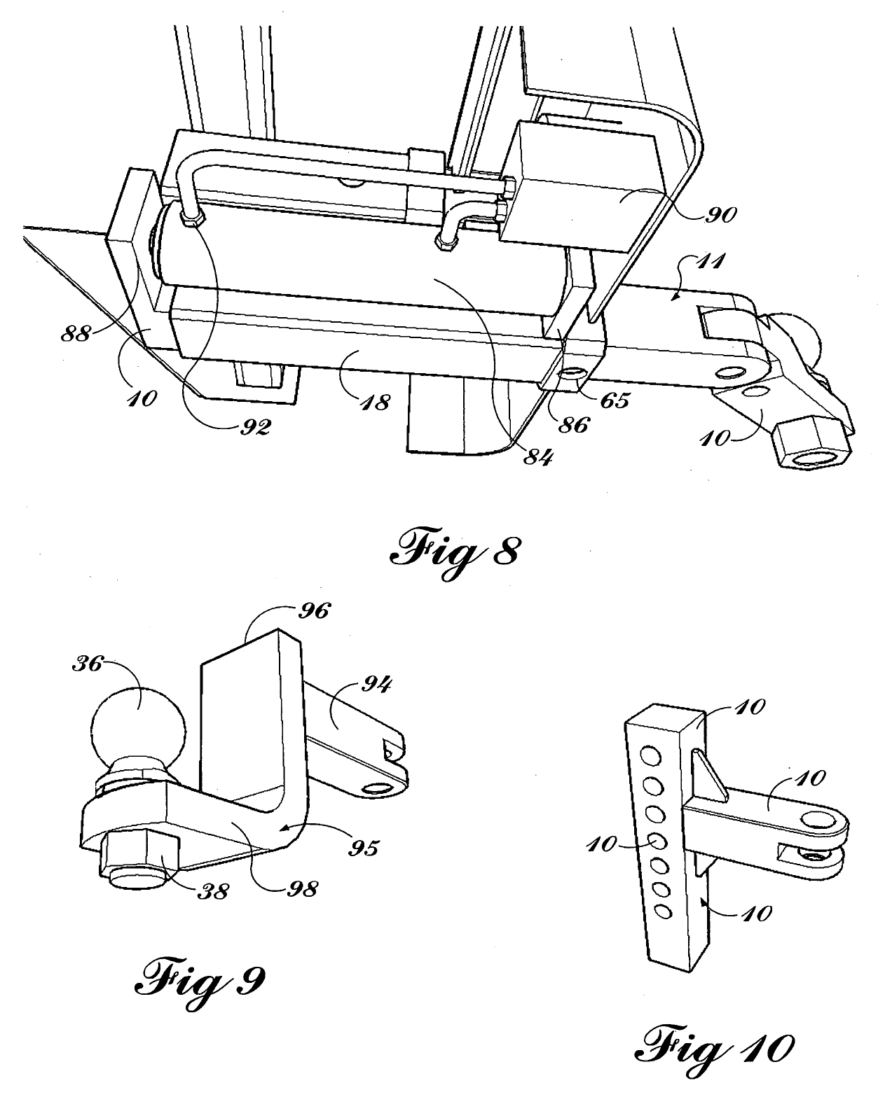

FIG. 8 illustrates an Industry Standard Hydraulic Ram 84 and Pump 90 method to both extend and retract the Telescoping Stinger Assembly 11. Hydraulic Ram 84 is permanently attached to projecting Surface 86 on Tube 18. The other end of the Hydraulic Ram 84 is affixed to Surface 88 of Telescoping Stinger Assembly Component 10. A Hydraulic Pump 90 is affixed to any Support Member and Hydraulic Lines 92 are routed to the various connections to the Ram 84. The Hydraulic Ram 84 is a double action Cylinder that will cause it to pressurize in both directions to either extend or retract the Telescoping Stinger Assembly 11.

### Description of Alternate Ball Mount #1

FIG. 9 illustrates a Ball Mount Assembly 95 that provides a much lower mounting Surface 98 for the Hitch Ball 36 that is often required when larger Tow Vehicles are used such as 4-wheel Drive Pickup Trucks. Forward portion 94 of this embodiment, inserts into Telescoping Stinger 10 described in the other Figures. The Geometry and Holes are identical to those of Item 10. Stinger portion 94 is inserted into Telescoping Stinger Item 10 and is secured with Pivot Pin item 14 as in the other Figures. This Assembly 95 can also be flipped up 180 degrees to allow a much higher Ball Mount, by reversing Hitch Ball 36 also 180 degrees.

### Description of Alternate Ball Mount #2

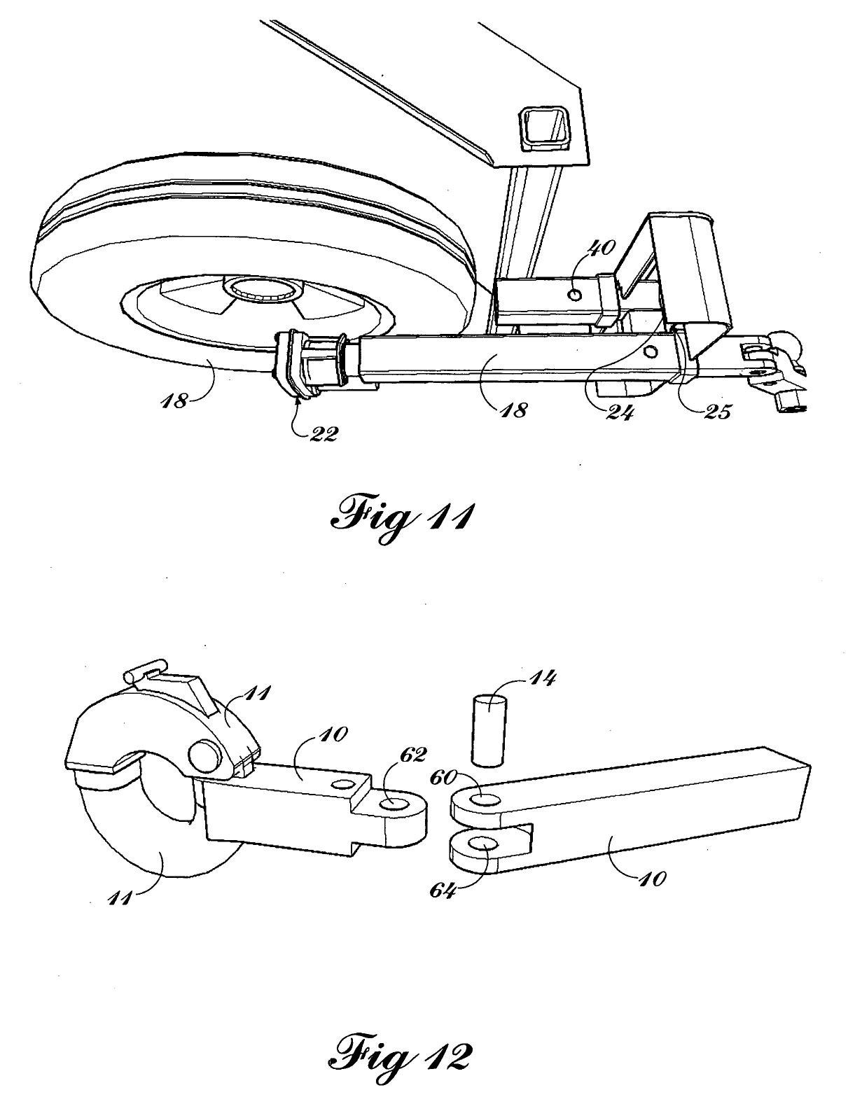

FIG. 10 illustrates a Ball Mount Stinger 106 commonly used in Equalizing Tow situations where Equalizing Components are used. Stinger portion 100 contains the same Geometry and Holes as in the other Figures that describe Telescoping Stinger items 10 & 12. The Holes and Geometry interface with Item 10 and are secured with Pivot Pin 14. Vertical Member 102 has Holes 104 that common Hitch Ball Mounts are bolted to (commercially available). Multiple Holes 104 allow for several Vertical positions of the common Industry Standard Equalizing Ball Mounts.

### Description of Alternate Pintle Hook

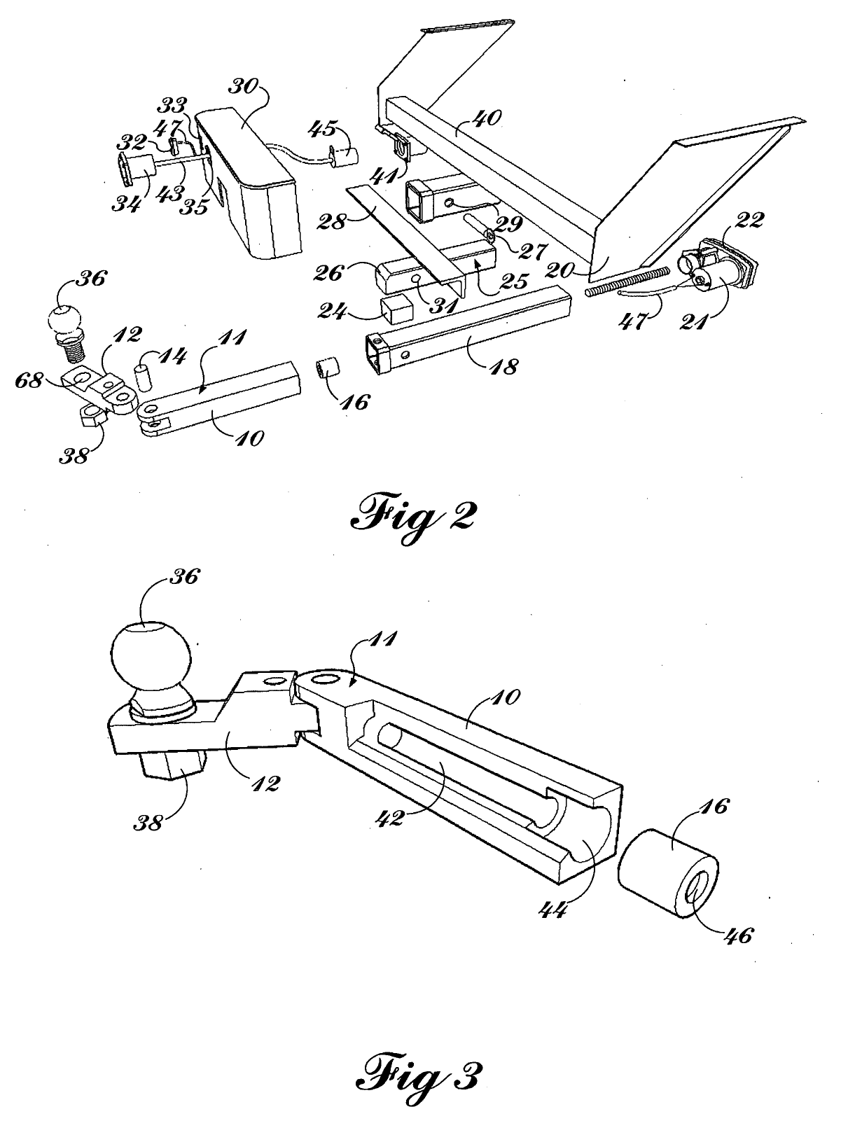

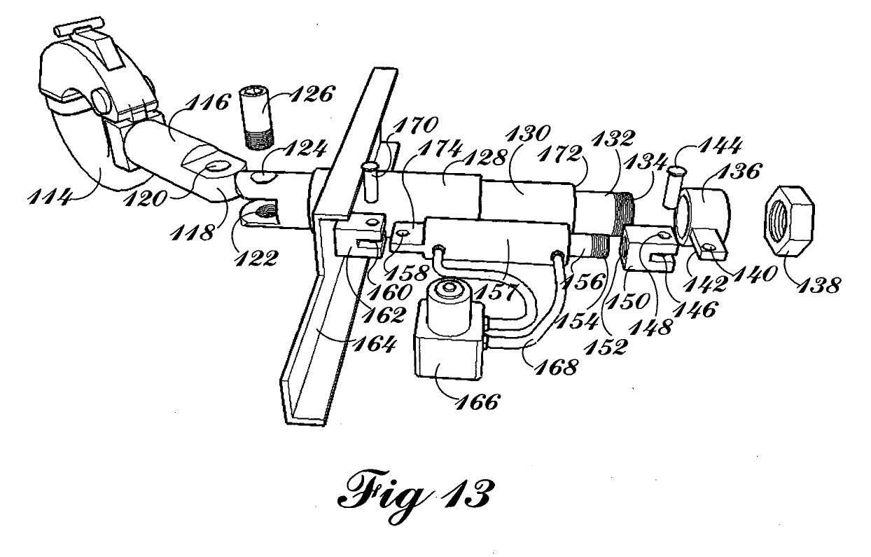

FIG. 12 illustrates a Pintle Hook adapted to interface with Telescoping Stinger Assembly Part 10 of Assembly 11 in the other figures. Pintle Hook 110 is an Industry Standard Component. Pintle Hook Assembly 112, is adapted with a projection Stub Embodiment 108 that will interface with the clevis-style end of Telescoping Stinger Component 10 of Assembly 11 (FIG. 3 ref). Pivot Pin 14 inserts into Holes 60, 62 & 64, the same as in FIG. 5. This style Coupling arrangement is often used with Heavy Equipment such as Farming Machinery, Dump Trucks with “Pup Trailers,” and many Military applications. It must also be noted that heavy Military applications require the Pintle Hook 110 to swivel 360 5 degrees. Therefore, all Embodiments in Telescoping Stinger Assembly 11, and Tube Assembly 18, (FIG. 3 ref), must be round in form, instead of square illustrated in the previous Embodiments. The following Specification describes this Style Connection.

FIG. 13 illustrates a Pintle Hook 114, adapted to a 360 degree rotatable Trailer Hitching Connection used on some Military Vehicles. Pintle Hook 114 contains a round Stub Embodiment 116 that has a Tongue form 118 that interfaces with the Clevis end of Telescoping Stinger 130. Pivot Pin 126 passes down through Holes 120 and 124 and screw into threads 122 in the pivotal end of Telescoping Stinger 130 to secure the connection. Telescoping Stinger 130, telescopes in and out through Sleeve Member 128 that is affixed to Cross Member 164 of the Tow Vehicle. Telescoping Stinger 130 has a step down diameter 132 that accepts a Sleeve 136 with Lug 142. Sleeve 136 is secured over diameter 132 by Nut 138 that screws on thread 134 to secure the Sleeve 136. Cross Member 164 has Clevis 162 affixed and contains Holes 158 and 160. The Tongue portion 171 of double acting Hydraulic Ram 157 is secured by Pin 170 that passes down through the Holes 158 and 160 in Clevis 162. The other end of Hydraulic Ram 157, has a Clevis 150 that contains threads 152 that screw on the Ram Cylinder end 156 via threads 154. Lug 142 interfaces with Clevis end 150 and Pin 144 passes through Holes 140, 146 and 148 to secure the Connection. Hydraulic Pump 166 is affixed to a nearby Frame Member and Hydraulic Lines 168 are routed to Hydraulic Ram 157. The operation of the Hydraulic Ram 157 causes the Telescoping Stinger Assembly 130 to extend and retract the Pintle Hook 114 as in all the other Embodiments previously illustrated. The round forms of these Embodiments allow Pintle Hook 114 to rotate 360 degrees inside Sleeves 128 and 136.

### Convenient Changing of Alternate Ball Mounts

FIG. 5 illustrates the convenient method of changing from one style Ball Mount to another. By inserting ones' finger up through the Hole 66, Pivot Pin 14 can be raised upwardly so it can be grasped from the top and removed. Once Pivot Pin 14 is removed, Ball Mount 12 can be interchanged with any of the Alternate Ball Mounts described above. The Pivot Pin 14 passes through Holes 60, 62 & 64, but the diameter does not allow it to pass through Hole 66 in the bottom of Telescoping Stinger 10, which is smaller in diameter than the other three. Being held in by gravity, it must be noted that when the Telescoping Stinger Assembly 11 is in the extended outwardly position (when the Ball Mount 12 can be swivelled from side to side), the Vehicles are not in motion and there is no danger of the Pivot Pin 14 coming out. When the Telescoping Stinger Assembly 11 is retracted back into Receiver Tube 18, the Pivot Pin 14 will be enclosed inside the Receiver Tube 18 and is totally enclosed, preventing it from coming out.

### Spare Tire Clearance

FIG. 11 illustrates the Components employed to provide clearance for the Spare Tire 18 that resides immediately behind the Industry Standard Hitch Receiver 40 on most Pickup 6 Trucks. Item 24 is a Spacer that is welded to the Stinger Assembly 25 described in FIG. 2. This Spacer 24 suspends Stinger Tube 18 and Hitch Drive Assembly 22, such that it does not interfere with the Spare Tire under the chassis on the Vehicle, therefore not requiring removal of the Spare Tire 18.

### Concluding Comments

Coupling and decoupling a Tow Vehicle to a Trailer can be a real challenge, especially when one is alone without any assistance. Rarely, can even the most experienced Operator align the Tow Vehicle with the Trailer without backing back and forth a few times. This Invention will allow the Operator a generous amount of misalignment in all directions. No longer will he or she be required to align directly under the Coupler on the Trailer. The Operator only needs to get reasonably close. The unique features described and illustrated in this Application will make this task an easy operation. Although other unique Embodiments in other Inventions that may contain some sort of telescoping and/or features like what is illustrated here might be derived from these, the Embodiments described and illustrated in this Application contain features that allow it to be used with already installed Standard Hitch Receivers found on most Tow Vehicles today, including those of the Military. Vehicle owners would not be required to remove these Standard Components from their Vehicles to install this Invention which would be very costly.

1. A Telescoping and Articulated Trailer Hitch Assembly comprising:
a. a telescope extension tube (18) slidably receives a trailer hitch extension (10); the trailer hitch extension (10) is rotatably affixed to a trailer hitch ball assembly (12) by a pivot pin (14); the pivot pin (14) has a diameter and is pivotally received by at least one outwardly extending upper pivot pin receiver having a pivot pin aperture (60) and by at least one outwardly extending lower counterbore receiver having a counterbore (64); the at least one upper pivot pin aperture (60) and the at least one lower counterbore (64) have an inside diameter greater than the pivot pin (14); the at least one lower counterbore (64) is penetrated, at the bottom, by an access aperture (66) which allows upward force to be applied to the pivot pin (14) for ease of removal and replacement of the trailer hitch ball assembly (12) with a different hitch style; the trailer hitch ball assembly (12) has at least one outwardly extending hitch pivot pin aperture (62) which has a diameter greater than the pivot pin (14) diameter; the alignment of the pivot pin aperture (60), the hitch pivot pin aperture (62) and the lower counterbore (64) allows the insertion of the pivot pin (14);
b. the trailer hitch extension (10) is extended by a drive interconnection with a Gearhead and Motor Drive Subassembly (22), which drives an Acme Screw (20), via an actuated Acme Screw Drive (21), to extend or retract the trailer hitch extension (10);
c. when the Acme Screw Drive Assembly 22 is driven in one direction, the trailer hitch extension (10) is telescoped outwardly allowing a Ball Mount (12) to swing to either the left or right via the Pivot Pin (14) thus allowing a generous amount of misalignment between a Tow Vehicle and a Trailer.
